(19) United States
(12) Patent Application Publication
(10) Pub. No.: US 2009/0261211 A1
(43) Pub. Date: Oct. 22, 2009

(54) Cable Management System

(75) Inventors: Nadia Anguiano-Wehde, Rochester, MN (US); Karl Klaus Dittus, Durham, NC (US); Stephen Peter Mroz, Rochester, MN (US); Rebeccah Jane Vossberg, Rochester, MN (US)

Correspondence Address: IBM CORPORATION (SS/NC);c/o STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NY (US)

(21) Appl. No.: 12/107,022

(22) Filed: Apr. 21, 2008

(51) Int. Cl. F16L 5/00

(52) U.S. Cl. 248/56

(57) ABSTRACT

A cable management system for a rack-mounted electronic system including an elongate cable guide plate securable to a rack and having opposing first and second, longitudinally-extending flanges. An array of cable alignment tabs are disposed on the cable guide plate between the opposing flanges and arranged in longitudinally-oriented columns and laterally-oriented rows. Adjacent columns are sufficiently spaced to receive two or more cables against the cable guide plate and adjacent rows are sufficiently spaced to receive one or more cables. Each of a plurality of cable-fastening straps are configured for being selectively secured across the cable guide plate from the first flange to the opposing second flange.

### BACKGROUND OF THE INVENTION

1. Field of the Invention

The present invention relates to systems for managing and securing cables in rack-mounted computer systems.

2. Description of the Related Art

A data center is a facility designed for housing one or more modular, rack-mounted computer system (“rack system”) and associated equipment. Each rack system includes a rack that accommodates computer equipment, primarily in the form of modular computer components. The rack positions the computer equipment in an organized, closely-packed arrangement that makes efficient use of space and places these components within easy reach of data center personnel. A data center typically includes redundant power supplies and communication connections for the various equipment, along with environmental controls such as air conditioning and fire suppression systems.

The computer equipment in a rack system typically provides several different connection types for interconnecting the various components, such as internal midplane or backplane connectors, Ethernet switches for making network connections, and cabling. Cabling is a convenient and versatile way for personnel to connect components located in different positions on a rack. Cables are typically routed externally to the rack for access by personnel. Computer suppliers may at least partially assemble a rack system along with the necessary cabling and ship the pre-cabled rack system to the customer. Data center personnel in charge of administering the rack system may route and periodically re-route cables as modular components are changed and moved in the process of using and maintaining the rack system.

Because cabling is prevalent in rack systems, cable management is an important consideration in the design, shipping, installation, and management of rack systems. Numerous cable connections may be required in a rack, particularly due to the large number of components that may be mounted on a rack and the number of connectors that may be provided on each component. Therefore, the ease and efficiency of setting up and maintaining a rack system depends, in part, on how the cables are managed, including how well the cables are arranged and secured on the rack. A well-organized cabling system makes it easier and faster to route the cables between components and to the outside of the rack system. Due to the visibility of externally-routed cables, the manner in which cables are organized also affects the appearance a rack. The aesthetics of a rack is especially important in newer rack systems that provide cabling on the front of the rack. The manner in which the cables are secured to the rack is also particularly important when assembling a pre-cabled system to be shipped.

### SUMMARY OF THE INVENTION

A first embodiment provides a cable management system for a rack-mounted electronic system. The cable management system includes an elongate cable guide plate securable to a rack, having opposing first and second, longitudinally-extending flanges. An array of cable alignment tabs are disposed on the cable guide plate between the opposing flanges, and are arranged in longitudinally-oriented columns and laterally-oriented rows, with sufficient spacing between adjacent columns to receive two or more cables against the cable guide plate between adjacent columns and with sufficient spacing between adjacent rows to receive one or more cables. Each of a plurality of cable-fastening straps are configured for being selectively secured across the cable guide plate from the first flange to the opposing second flange. Preferably, each strap is secured between the first and second flanges at longitudinal positions between adjacent rows.

A second embodiment provides a rack-mounted computer system. The rack-mounted computer system includes a rack having a plurality of vertically-spaced chassis bays for receiving one or more component chassis. Each component chassis has one or more module bays, each configured for removably receiving an electronic component. An elongate cable guide plate is secured to the rack and spans a plurality of the vertically-spaced chassis bays. The cable guide plate has opposing first and second, vertically-extending flanges and an array of cable alignment tabs arranged in vertically-oriented columns and horizontally-oriented rows between the opposing flanges. Each of a plurality of electronic cables are configured for connecting to selected connectors of the electronic components. The electronic cables are routed along the cable guide plate between adjacent columns of cable alignment tabs. Each of a plurality of vertically-spaced straps are releasably securable across the cable guide plate from the first flange to the second flange for securing the plurality of cables to the cable guide plate.

A third embodiment provides a method of assembling a rack-mounted computer system. Each of a plurality of electronic components are removably supported on a rack in a vertically-spaced relationship. First and second electronic cables are routed along the rack between an array of cable alignment tabs, including routing the first and second electronic cables between adjacent vertical columns of the cable alignment tabs, routing at least a third electronic cable on top of and between the first and second electronic cables between the adjacent vertical columns of cable alignment tabs, and routing a portion of each of the first, second, and third electronic cables horizontally between adjacent rows of the cable alignment tabs. The first, second, and third electronic cables are secured between the adjacent vertical columns of cable alignment tabs with a plurality of vertically-spaced straps.

Other details and embodiments of the invention will be apparent from the following description and the appended claims.

### BRIEF DESCRIPTION OF THE DRAWINGS

FIG. 1 is a perspective view of an exemplary rack having a cable management system according to one embodiment of the invention.

FIG. 2 is a detailed perspective view of the cable management system with an exemplary positioning of the three cables.

FIG. 3 is another detailed perspective view of the cable management system with a plurality of longitudinally-spaced straps secured from the first flange to the second flange to secure the cables to the guide plate.

FIG. 4 is a cross-sectional view of the cable guide plate taken along section-lines A-A of FIG. 3, illustrating one example of releasably securing the strap across the cable guide plate.

FIG. 5 is a cross-sectional view of the cable guide plate taken along section-lines A-A of FIG. 3, illustrating an alternative way of releasably securing the strap across the cable guide plate.

FIG. 6 is a cross-sectional view of the cable guide plate taken along section lines A-A of FIG. 3, highlighting a preferred arrangement of the cables between the adjacent columns of cable alignment tabs.

FIG. 7 is the cross-sectional view of FIG. 6 with the strap released and removed from the flange.

FIG. 8 is another cross-sectional view of the cable guide plate with an alternative arrangement of cables.

FIG. 9 is another cross-sectional view of the cable guide plate wherein a single layer of cables are routed and secured between two of the tabs with an additional strap.

FIG. 10 is a perspective view of the cable guide plate connected end-to-end with a second cable guide plate.

### DETAILED DESCRIPTION OF PREFERRED EMBODIMENTS

Embodiments of the invention include a cable management system for a rack-mounted electronic system. The rack-mounted electronic system is typically a rack-mounted computer system having a number of component chassis supported on a rack, with one or more modular computer components provided in each component chassis. One embodiment of the cable management system includes a cable guide plate that may fit in a compact allocation of space, such as 1 EIA (44.45 mm×450 mm), and which guides and supports a group of selectively routed cables for connecting the various components. The group of cables carried and supported on the cable guide plate is separated into smaller subsets between longitudinally-extending columns of cable alignment tabs. The cable management system allows individual cables to exit the group at various vertical positions corresponding approximately to the vertical positions of various components mounted in the rack. The cables may individually exit the group with a gentle bend radius on the path to the components the cables are connected to. Cables secured to the cable guide plate are individually serviceable without appreciably disturbing other cables. The cable guide plate also allows an entire bundle of cables to exit the cable guide plate at selected vertical locations, such as to pass from the front of the rack where the cable guide plate is located to the rear of the rack or to the outside of the rack. The cable guide plate is also modular, allowing multiple cable guide plates to be oriented end to end. The cable management system provides a desirably low part count, and the modular design of the cable guide plate allows for easy disassembly for compact packaging and shipping of the cable management system. The cable guide plate accommodates various combinations of cable diameters and various number of cables. Further details, embodiments, and applications thereof are provided below with reference to the accompanying figures.

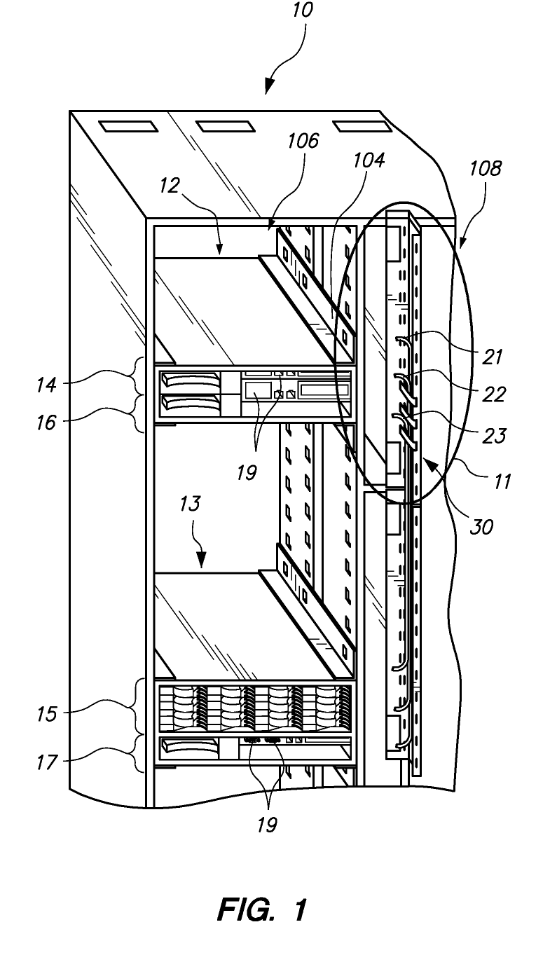

FIG. 1 is a perspective view of an exemplary rack 10 having a cable management system 11 according to one embodiment of the invention. The rack 10 accommodates a plurality of vertically-spaced component chassis supported on horizontally opposing rails 104 in two vertical columns 106, 108. The rails 104 provide vertically-spaced chassis mounting locations referred to as chassis bays. The vertical spacing between the rails 104 may be individually adjustable, and the rails are provided at various vertical spacings to accommodate different sizes of chassis. For example, the rails 104 are vertically-spaced a first distance to provide a chassis bay for receiving a 2U chassis 12, and a second distance to provide a chassis bay for receiving a 3U chassis 13. Each chassis includes module bays for receiving various modular electronic components (“modules”). For example, the 2U chassis 12 has an expansion module 14 disposed in an upper bay and a compute module 16 (e.g. a blade server) disposed in a lower bay. The 3U chassis has twelve 3.5 inch disk drives 15 installed into drive bays that are a permanent part of the chassis 13, and a compute module 17 installed in a lower bay. Other examples of electronic modules include computer hardware modules such as hard drive modules, PCI card modules, network switches, or other modular computer hardware assemblies.

Various external electrical connectors 19 of different types known in the art are provided on the front of some of the modules in the rack 10. Each electrical connector 19 is an interface that allows an electronic device (in this case, the various modules) to be removably connected to another electronic device, to provide electronic communication between the connected devices. A cable may be used to couple each connector 19 with the connector on another device over some distance by connecting one end of the cable to one connector 19 and the other end of the cable to the other connector. The cable management system 11 is therefore provided to manage the numerous cables that will be present in the rack 10. The cable management system 11 includes a vertically-extending cable guide plate 30 spanning a plurality of chassis bays for routing the cables to modules at different vertical positions in the rack 10. Here, three exemplary cables 21, 22, 23 are shown routed to three different locations. These cables can run to modules in different vertical positions in the rack, to a horizontally mounted network switch in column 106, or even to the outside of the rack via the top or bottom openings of the rack. Other cables may be routed along the guide plate 30 to other locations within the rack 10.

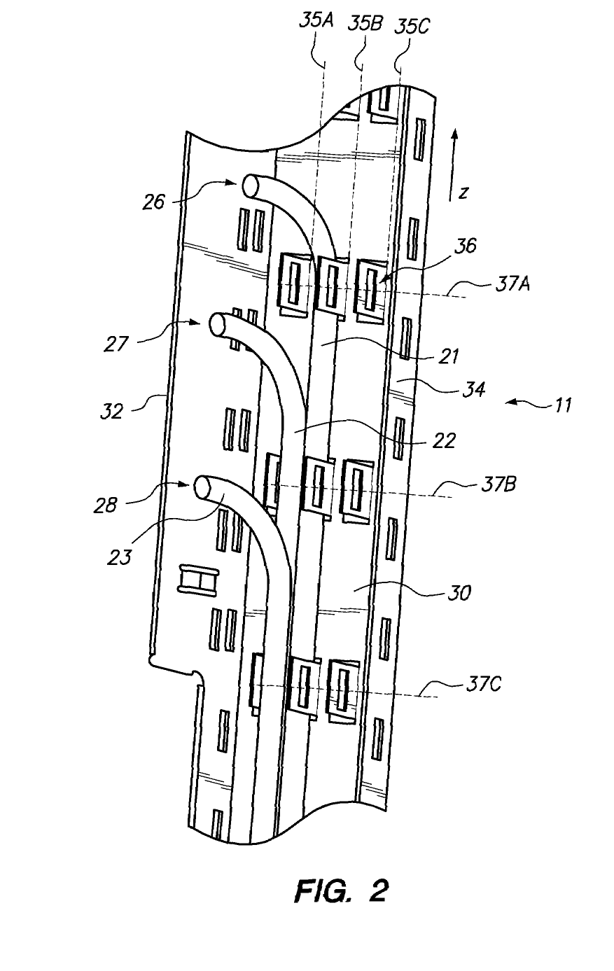

FIG. 2 is a detailed perspective view of the cable management system 11 with an exemplary positioning of the three cables 21-23. The cable guide plate 30 includes a first longitudinally-extending flange 32 and a second longitudinally-extending flange 34 opposite the first longitudinally-extending flange 32. An array of cable alignment tabs 36 are positioned between the first and second longitudinally-extending flanges 32, 34, wherein each tab is preferably longitudinally-extending, parallel to the flanges. The cable guide plate 30 may be formed from sheet metal. The opposing flanges 32, 34 may be formed by folding edges of the sheet metal. Each alignment tab 36 may be formed by stamping tab-shaped forms in the sheet metal between the flanges 32, 34 and folding the tab 36 out from the original plane of the sheet metal. In this embodiment, the array of cable alignment tabs 36 is a rectangular array, with the cable alignment tabs 36 arranged in longitudinally-extending columns 35 (individually designated 35A, 35B, 35C, etc.) and laterally-extending rows 37 (individually designated 37A, 37B, 37C, etc.). The vertically-oriented position of the cable guide plate 30 on the rack 10 in FIG. 1 results in the longitudinally-extending columns 35 being vertically oriented and the laterally-extending rows 37 being horizontally-oriented in the rack 10. Adjacent columns 35 of alignment tabs 36 are spaced to receive a plurality of cables longitudinally-routed along the cable guide plate 30. The three exemplary cables 21-23 are shown longitudinally oriented along the cable guide plate 30 between adjacent columns 35A, 35B. Each cable 21-23 is routed longitudinally and vertically to different longitudinal positions 26, 27, 28 before bending with a gentle bend radius in a lateral/horizontal direction, to route each cable 21-23 to the various vertical locations of the connectors 19 of FIG. 1 or to a switch that has been horizontally or vertically mounted to the rack. The cables 21-23 may be routed as shown by personnel at a manufacturing and/or assembly stage of the rack 10.

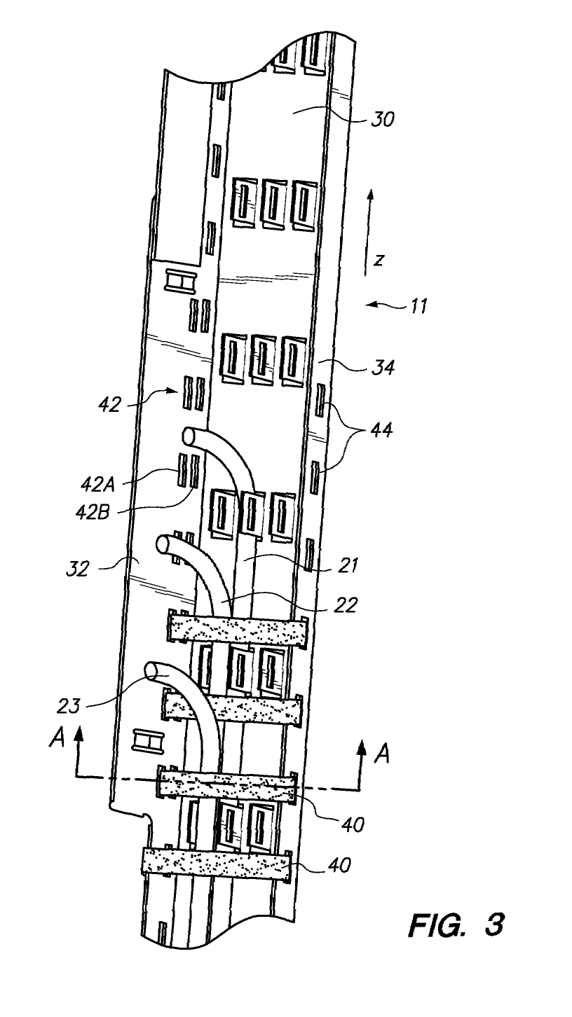

FIG. 3 is another detailed perspective view of the cable management system 11 with a plurality of longitudinally-spaced straps 40 secured from the first flange 32 to the second flange 34 to secure the cables 21-23 to the guide plate 30. A first plurality of strap through-holes 42, which in this embodiment are slots 42, are longitudinally-spaced along the first flange 32. The slots 42 on the first flange 32 optionally include a pair of slots 42A, 42B at each longitudinal position, although another suitable arrangement would be to provide only one slot 42 at each longitudinal position. A second plurality of slots 44 are longitudinally-spaced along the second flange 34. Each slot 42, 44 is sized to receive an end of one of the straps 40. The slots 44 are generally aligned in one-to-one correspondence with the slots 42, so that for each slot 42 or pair of slots 42A, 42B on the flange 32 there is an opposing slot 44 at substantially the same longitudinal position on the opposing flange 34. This alignment of the slots 42 on the first flange 32 with the slots 44 on the second flange 34 allows the straps 40 to be horizontally, laterally oriented across the cable guide plate 30. A strap 40 may be used at any selected longitudinal location of the slots 42, 44 to secure the cables 21-23 along the cable guide plate 30. Preferably, each set of opposing slots is positioned longitudinally between adjacent rows, such that the straps hold down any number of cables even if the cables to not exceed the height of the tabs 36. The straps 40 may have a flat, substantially rectangular cross-section as shown, to fit the particular shape of the slots 42, 44. However, the term “strap” is meant to broadly include other functionally equivalent flexible members that do not necessarily have flat, rectangular cross-sections. For example, a strap according to the invention may be a cord having a substantially circular cross-section, and the strap through-holes may be substantially circular through-holes in the flanges 32, 34.

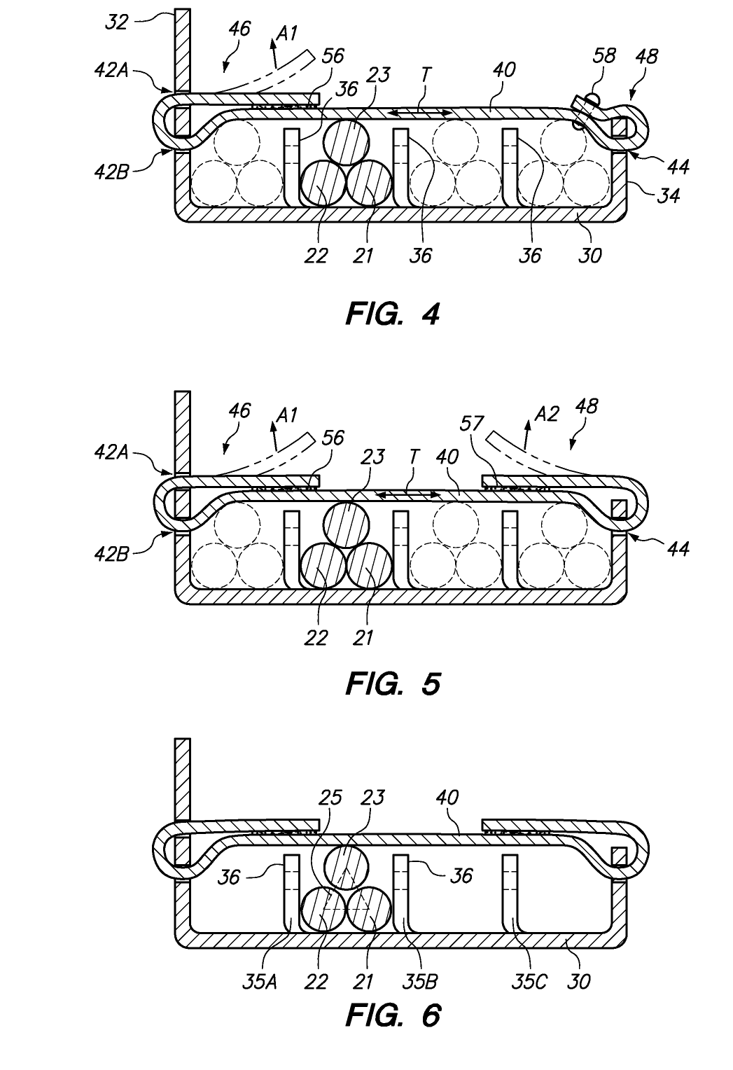

The straps 40 may each be releasably secured across the cable guide plate 30 in a variety of ways. FIG. 4 is a cross-sectional view of the cable guide plate 30 taken along section-lines A-A of FIG. 3, illustrating one example of releasably securing the strap 40 across the cable guide plate 30. The strap 40 has opposing first and second ends 46, 48. The second end 48 has been permanently secured to the second flange 34 by passing the second end 48 of the strap 40 through the slot 44 on the second flange 34, looping the second end 48 of the strap 40 back over the second flange 34, and securing the second end 48 of the strap 40 back to the strap 40 with a second connector 58. In this embodiment, the second connector 58 is a rivet 58 that permanently secures the second end 48 of the strap 40 to the second flange 34. Permanently securing the second end 48 of the strap 40 to the second flange 34 ensures that the strap 40 remains attached to the cable guide plate 30. The first end 46 of the strap 40 is pulled to place the strap 40 in tension across the cable guide plate 30, and the first end 46 is releasably secured to the first flange 32 by passing the first end 46 of the strap 40 through the slot 42B, looping the first end 46 of the strap 40 back through the slot 42A, and releasably securing the first end 46 of the strap 40 back to a portion of the strap 40 between the opposing flanges 32, 34 using a hook-and-loop type fastener 56. The hook-and-loop fastener 56 is just one example of releasable fastener that allows the first end 46 of the strap 40 to be selectively released from the first flange 32 by lifting up the first end 46 of the strap 40 in the direction of the arrow A1. For example, a user may release the first end 46 of the strap 40 to selectively access, remove, or reposition the various cables 21-23.

FIG. 5 is a cross-sectional view of the cable guide plate 30 taken along section-lines A-A of FIG. 3, illustrating an alternative way of releasably securing the strap 40 across the cable guide plate 30. In this example, both ends 46, 48 of the strap 40 are releasably secured to the respective flanges 32, 34 using the hook and loop fastener 56 at the first end 46 and a second hook and loop fastener 57 at the second end 48. For example, the first end 46 of the strap 40 may be releasably secured to the first flange 32 by passing the first end 46 of the strap 40 through the slot 42B, looping the first end 46 of the strap 40 back through the slot 42A, and securing the first end 46 of the strap 40 back to a portion of the strap 40 between the opposing flanges 32, 34 using the hook-and-loop type fastener 56. Then, the second end 48 of the strap 40 may be routed by hand over the cables 21-23 to the second flange 34, inserted through the slot 44, pulled to place the strap 40 in tension, and looped back over the flange 34 and re-secured to the strap 40 with the hook and loop fastener 57. Either end 46, 48 of the strap may be selectively released by lifting the first end 46 of the strap 40 in the direction A1 to separate the first hook and loop fastener 56, or by lifting the second end 48 of the strap 40 in the direction A2 to separate the second hook and loop fastener 57. The entire strap 40 may be released and removed from the cable guide plate 30 if desired. The use of hook and loop fasteners 56, 57 at both ends 46, 48 of the strap 40 may be desired, for example, to allow for easy replacement of the straps 40 or for easy positioning and repositioning of the straps 40 at another longitudinal location of the cable guide plate 30.

FIG. 6 is a cross-sectional view of the cable guide plate 30 taken along section lines A-A of FIG. 3, highlighting a preferred arrangement of the cables 21-23 between the adjacent columns 35A, 35B of cable alignment tabs 36 (the columns 35A, 35B are orthogonal to the page in FIG. 6). The cable 23 is stacked on and between the cables 21, 22, with the cross-sections of the cables 21-23 forming a generally triangular stacking relationship indicated at 25. The triangular stacking relationship 25 makes all three cables 21-23 visible to the user for easily visually identifying the cables 21-23. This visibility is provided even with the strap 40 secured across the cable guide plate 30 as shown, due to the longitudinal spacing between straps along the cable guide plate 30. The cables 21-23 are shown as having the same diameter for simplicity of discussion, but the cable guide plate 30 easily supports cables of different diameters, as well.

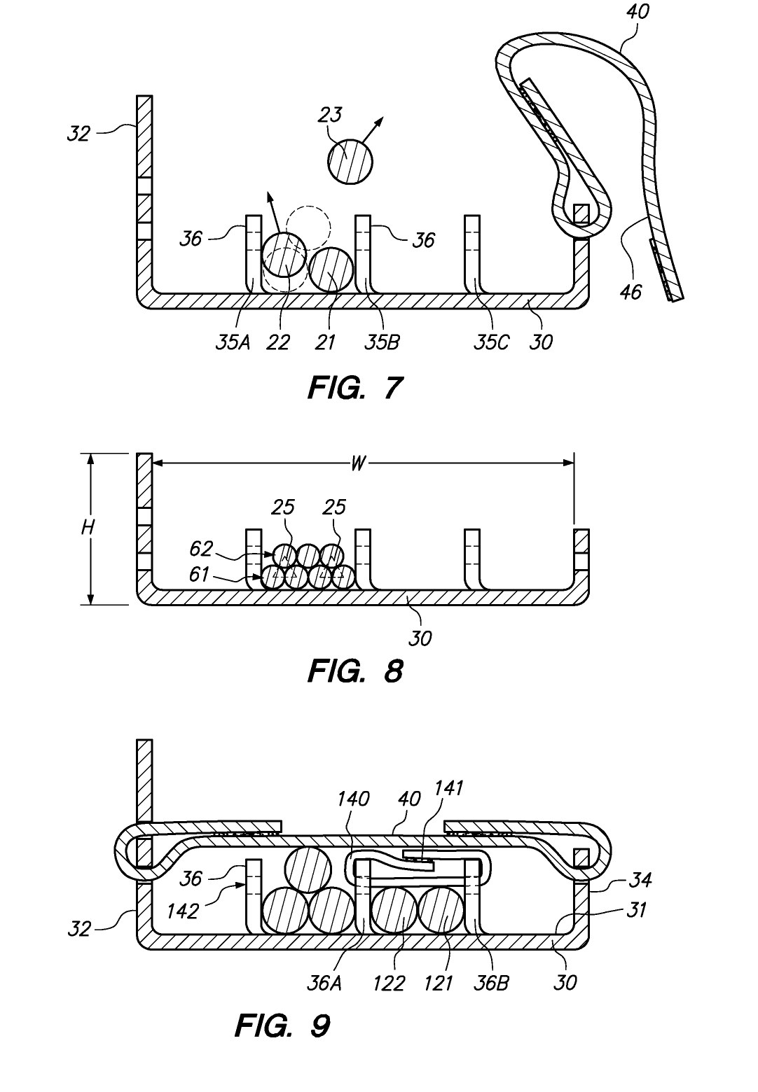

FIG. 7 is the cross-sectional view of FIG. 6 with the strap 40 released and removed from the flange 32. After visually identifying which of the three cables 21-23 the user desires to access, the user may release and remove the strap 40 from the flange 32 to access the cables 21-23. For example, if the user wants to remove the cable 22, the user may visually identify the cable 22 in it is position of FIG. 6, remove and release the strap 40 from the flange 32 as discussed above, pull cable 23 slightly away from the cable guide plate 30 in the direction shown, and then remove the cable 22 in the direction shown. The user may then re-secure the first end 46 of the strap 40 as shown in FIG. 6, and such as described with reference to FIGS. 4 and 5.

The cable guide plate 30 has the capacity to hold several cables, divided in subsets between the adjacent columns 35A, 35B, 35C, and between the flange 32 and the column 35A and between the column 35C and the flange 34. Dividing the cables into smaller subsets provides for easy access to and handling of the cables 21-23. However, embodiments of the invention are not limited to three cables per subset. For example, FIG. 8 is another cross-sectional view of the cable guide plate 30 with a first layer 61 of four cables against the guide plate between adjacent columns 35A, 35B, and a second layer 62 of three cables stacked on and between the cables of the first layer 61. As indicated at 25, the triangular stacking pattern is generally maintained even though more than three cables are positioned between the adjacent columns 35A, 35B.

The stacking of cables increases the cable carrying capacity of the cable guide plate 30 within a specified width W and a height H of the cable guide plate 30. For example, the height H of the cable guide plate 30 may be limited to no more than 1 “EIA.” One EIA of space in this context refers to a “1U” panel height of 44.45 mm that can be mounted in a rack between two EIA mounting flanges 450 mm apart per the Electronic Industries Association (EIA) Standard EIA-310-D “Cabinets, Racks, Panels, and Associated Equipment”. The ability of the cable guide plate 30 to accommodate the stacking of cables increases the cable-carrying capacity of the cable guide plate 30 even within the hypothetical constraint of H=44.45 mm.

While the ability to stack cables increases the cable-carrying capacity of the cable guide plate 30, it may not be necessary to stack cables in every instance. For example, FIG. 9 is a cross-sectional view of the cable guide plate 30 taken along section lines A-A of FIG. 3 wherein only two cables 121 122 are routed between two of the tabs 36A, 36B. The cables 121, 122 fit between the tabs 36A, 36B without stacking, such that a substantial gap is present between the strap 40 and the cable 121, 122. As a consequence, the strap 40 secured between the flanges 32 to 34 may not retain the cables 121, 122 tightly against the cable guide plate 30. Therefore, to hold the single layer of cables 121, 122 more securely against the cable guide plate 30, additional slots 142 are provided on each of the tabs 36. The slots 142 have a closer spacing to a surface 31 of the cable guide plate 30 than the slots 42A, 42B and 44 in the flanges 32, 34. Another hook-and-loop strap 140 is used to individually attach the cables 121, 122 to the tabs 36A, 36B to the cable guide plate 30 by feeding the strap 140 through the slot in 36, wrapping it around the tabs 36, and securing the strap 140 with a hook and loop fastener 141.

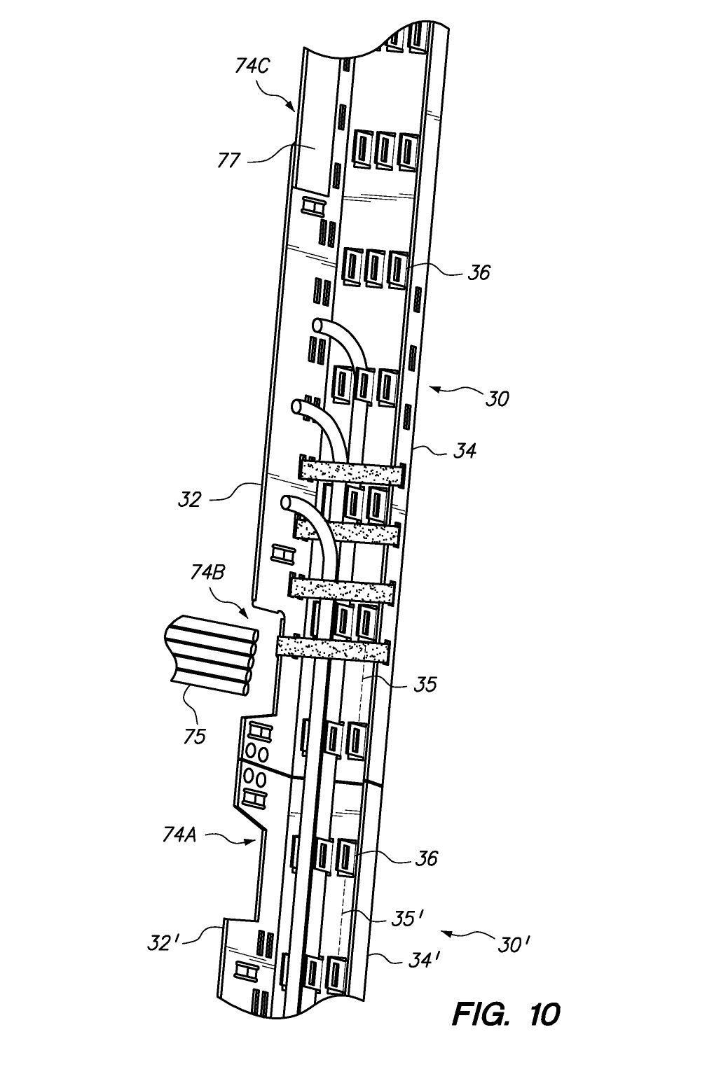

Multiple cable guide plates 30 may be arranged end-to-end to position and support cables over a greater distance. For example, FIG. 10 is a perspective view of the cable guide plate 30 connected end-to-end with a second cable guide plate 30′. Flanges 32, 34 on the first cable guide plate 30 are aligned with flanges 32′, 34′ on the second cable guide plate 30′, and the columns 35 of cable alignment tabs 36 on the first guide plate 30 are aligned with corresponding columns 35′ of the second guide plate 30′. This segmented construction of the cable guide plate 30 also simplifies shipping by shipping disassembled segments of a cable guide plate in a compact packaging.

FIG. 10 also shows exemplary windows 74A, 74B, 74C provided along the flanges 32 and 32′, each for conveniently routing cables to and from the cable guide plates 30, 30′. The flange windows 74A-C are made relatively wide to accommodate a relatively large bundle of cables 75. The flange windows 74A-C may be covered with a cover plate 77 when not in use, to minimize airflow losses through the flange openings 74A-C.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A cable management system for a rack-mounted electronic system, comprising:
an elongate cable guide plate securable to a rack and having opposing first and second, longitudinally-extending flanges;
an array of cable alignment tabs disposed on the cable guide plate between the opposing flanges and arranged in longitudinally-oriented columns and laterally-oriented rows, with sufficient spacing between adjacent columns to receive two or more cables against the cable guide plate between adjacent columns and with sufficient spacing between adjacent rows to receive one or more cables; and
a plurality of cable-fastening straps each configured for being selectively secured across the cable guide plate from the first flange to the opposing second flange.

2. The cable management system of claim 1, further comprising:
a first plurality of strap through-holes longitudinally-spaced along the first flange, each configured for receiving a first end of one of the straps; and
a first releasable fastener for releasably securing the received first end of the strap back to the strap for securing the strap to the first flange.

3. The cable management system of claim 1, wherein the first releasable fastener comprises a hook and loop fastener.

4. The cable management system of claim 2, further comprising:
a second plurality of strap through-holes longitudinally-spaced along the second flange in substantial alignment with the first plurality of strap through-holes, each of the second plurality of strap through-holes configured for receiving the second end of one of the straps; and
a second fastener for securing the received second end of the strap back to the strap for securing the strap to the second flange.

5. The cable management system of claim 1, wherein the second fastener comprises a releasable fastener for releasably securing the second end of the strap back to the strap.

6. The cable management system of claim 2, wherein each strap through-hole is longitudinally positioned between adjacent rows of cable alignment tabs.

7. A rack-mounted computer system, comprising:
a rack having a plurality of vertically-spaced chassis bays for receiving one or more component chassis, each component chassis having one or more module bays, each module bay configured for removably receiving an electronic component;
an elongate cable guide plate secured to the rack and spanning a plurality of the vertically-spaced chassis bays, the cable guide plate having opposing first and second, vertically-extending flanges and an array of cable alignment tabs arranged in vertically-oriented columns and horizontally-oriented rows between the opposing flanges;
a plurality of electronic cables configured for connecting to selected connectors of the electronic components, the electronic cables routed along the cable guide plate between adjacent columns of cable alignment tabs; and
a plurality of vertically-spaced straps releasably securable across the cable guide plate from the first flange to the second flange for securing the plurality of cables to the cable guide plate.

8. The rack-mounted computer system of claim 7, wherein the plurality of electronic cables comprises at least a first and second cable disposed against the cable guide plate and at least a third cable stacked on and between the first and second cables.

9. The rack-mounted computer system of claim 7, further comprising a window along one of the flanges, wherein at least a subset of the electronic cables are routed through the window to extend outside the opposing flanges.

10. The rack-mounted computer system of claim 9, further comprising a cover plate removably securable to the cable guide plate and substantially closing the window with the subset of electronic cables removed from the window.

11. The rack-mounted computer system of claim 7, further comprising a plurality of the cable guide plates aligned end-to-end.

12. The rack-mounted computer system of claim 7, wherein the cable guide plate is removably secured to the rack.

13. A method of assembling a rack-mounted computer system, comprising:
removably supporting a plurality of electronic components on a rack in a vertically-spaced relationship;
routing first and second electronic cables along the rack between an array of cable alignment tabs, including routing the first and second electronic cables between adjacent vertical columns of the cable alignment tabs, routing at least a third electronic cable on top of and between the first and second electronic cables between the adjacent vertical columns of cable alignment tabs, and routing a portion of each of the first, second, and third electronic cables horizontally between adjacent rows of the cable alignment tabs; and
securing the first, second, and third electronic cables between the adjacent vertical columns of cable alignment tabs with a plurality of vertically-spaced straps.

14. The method of claim 13, wherein the step of securing the first, second, and third electronic cables between the adjacent vertical columns of cable alignment tabs with a plurality of vertically-spaced straps comprises securing a first end of each strap to a first vertically-extending flange, placing the strap in tension across the first, second, and third electronic cables, and securing a second end of each strap to an opposing second flange.

15. The method of claim 14, wherein the step of securing the first end of each strap to the first flange comprises routing the first end of the strap through a strap through-hole on the first flange, looping the first end of the strap back and releasably securing the first end of the strap to a portion of the strap between the first and second flanges.

16. The method of claim 15, wherein the step of releasably securing the first end of the strap to a portion of the strap between the first and second flanges comprises securing the first end of the strap to the portion of the strap between the first and second flanges with a hook-and-loop fastener.

17. The method of claim 14, wherein the step of securing the second end of each strap to the second flange comprises routing the second end of the strap through a strap through-hole on the second flange, looping the second end of the strap back toward the portion of the strap between the first and second flanges, and releasably securing the second end of the strap to the portion of the strap between the first and second flanges.

18. The method of claim 17, wherein the step of releasably securing the second end of the strap to the portion of the strap between the first and second flanges comprises securing the second end of the strap to the portion of the strap between the first and second flanges with a hook-and-loop fastener.

19. The method of claim 14, wherein the step of securing the second end of each strap to the second flange comprises routing the second end of the strap through a strap through-hole on the second flange, looping the second end of the strap back toward the portion of the strap between the first and second flanges, and permanently securing the second end of the strap to the portion of the strap between the first and second flanges.

20. The method of claim 13, further comprising:
connecting ends of the horizontally-routed portions of the first, second, and third electronic cables to selected connectors on electronic components having different vertical positions.

21. The method of claim 13, further comprising selecting a subset of the electronic cables, bundling the selected subset of the electronic cables, and routing the bundled subset of the electronic cables through a window in one of the flanges outside of the opposing first and second flanges.

22. The method of claim 13, further comprising:
routing a single layer of other cables between other adjacent vertical tabs;
securing the single layer of other cables to the cable guide plate by routing another strap against the single layer of other cables and through slots on the other adjacent vertical tabs.
